(19) United States
(12) Patent Application Publication
(10) Pub. No.: US 2026/0099207 A1
(43) Pub. Date: Apr. 9, 2026

(54) HOST, OBJECT-BASED OPERATION SYSTEM AND METHOD

(71) Applicant: HTC Corporation, Taoyuan City (TW)

(72) Inventor: Chang-Hua Wei, Taoyuan City (TW)

(73) Assignee: HTC Corporation, Taoyuan City (TW)

(21) Appl. No.: 18/909,952

(22) Filed: Oct. 9, 2024

(51) Int. Cl. G06F 3/01; G06T 7/11; G06V 10/25; G06V 40/10

(52) U.S. Cl. CPC G06F 3/017; G06T 7/11; G06V 10/25; G06V 40/113; G06T 2207/20132

(57) ABSTRACT

A host is described herein. The host includes a storage circuit and a processor. The storage circuit is configured to store a program code. The processor is coupled to the storage circuit and configured to access the program code to execute: obtaining an environment image of an environment around a user; identifying one or more objects in the environment based on the environment image; performing a hand tracking to determine a hand track of a hand of the user; determining one or more pointing periods of the one or more objects based on the hand track; determining one of the one or more objects as a target object based on the one or more pointing periods; and performing an object-based operation based on the target object.

### BACKGROUND

### Technical Field

The disclosure relates to a host; particularly, the disclosure relates to a host, an object-based operation system, and an object-based operation method.

### Description of Related Art

In order to bring an immersive experience to user, technologies related to extended reality (XR), such as augmented reality (AR), virtual reality (VR), and mixed reality (MR) are constantly being developed. AR technology allows a user to bring virtual elements to the real world. VR technology allows a user to enter a whole new virtual world to experience a different life. MR technology merges the real world and the virtual world. Further, to bring a fully immersive experience to the user, visual content, audio content, or contents of other senses may be provided through one or more devices.

### SUMMARY

The disclosure is direct to a host, an object-based operation system, and an object-based operation method, so as to improve user experience of an object-based operation.

The embodiments of the disclosure provide a host. The host includes a storage circuit and a processor. The storage circuit is configured to store a program code. The processor is coupled to the storage circuit and configured to access the program code to execute: obtaining an environment image of an environment around a user; identifying one or more objects in the environment based on the environment image; performing a hand tracking to determine a hand track of a hand of the user; determining one or more pointing periods of the one or more objects based on the hand track; determining one of the one or more objects as a target object based on the one or more pointing periods; and performing an object-based operation based on the target object.

The embodiments of the disclosure provide an object-based operation system. The object-based operation system includes, a camera, a display, a storage circuit and a processor. The camera is configured to obtain an environment image of an environment around a user. The display is configured to display information about the environment to the user. The storage circuit is configured to store a program code. The processor is coupled to the storage circuit and configured to access the program code to execute: obtaining the environment image from the camera; identifying one or more objects in the environment based on the environment image; performing a hand tracking to determine a hand track of a hand of the user; determining one or more pointing periods of the one or more objects based on the hand track; determining one of the one or more objects as a target object based on the one or more pointing periods; and performing an object-based operation based on the target object.

The embodiments of the disclosure provide an object-based operation method. The object-based operation method includes: obtaining, through a camera, an environment image of an environment around a user; identifying, through a processor, one or more objects in the environment based on the environment image; performing, through the processor, a hand tracking to determine a hand track of a hand of the user; determining, through the processor, one or more pointing periods of the one or more objects based on the hand track; determining, through the processor, one of the one or more objects as a target object based on the one or more pointing periods; and performing, through the processor, an object-based operation based on the target object.

Based on the above, according to the host, the object-based operation system, and the object-based operation method, the object-based operation may be performed easily and conveniently, thereby improving the user experience.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an object-based operation scenario according to an embodiment of the disclosure.

FIG. 2A is a schematic diagram of a host according to an embodiment of the disclosure.

FIG. 2B is a schematic diagram of an object-based operation system according to an embodiment of the disclosure.

FIG. 3 is a schematic diagram of an object-based operation scenario according to an embodiment of the disclosure.

FIG. 4 is a schematic diagram of an object-based operation scenario according to an embodiment of the disclosure.

FIG. 5 is a schematic diagram of an object-based operation scenario according to an embodiment of the disclosure.

FIG. 6 is a schematic diagram of an object-based operation scenario according to an embodiment of the disclosure.

FIG. 7 is a schematic diagram of an object-based operation scenario according to an embodiment of the disclosure.

FIG. 8 is a schematic flowchart of an object-based operation method according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

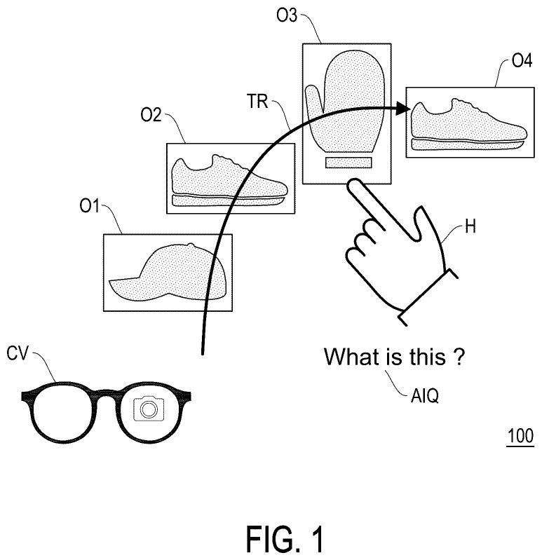

FIG. 1 is a schematic diagram of an object-based operation scenario according to an embodiment of the disclosure. In FIG. 1, an object-based operation scenario 100 may include an object O1, an object O2, an object O3, an object O4, a hand H, a hand track TR, a computer vision CV, and an artificial intelligence (AI) query AIQ. That is, in one embodiment, the object-based operation may be the AI query AIQ. However, this disclosure is not limited thereto. For example, the object-based operation may be storing an object, tagging an object, or other kinds of processing or reactions to the object. For the sake of convenience in explanation, in the following discussion, the AI query AIQ may be used as one exemplary embodiment of the object-based operation, but this disclosure is not limited thereto.

With reference to FIG. 1, a user may be in an environment with a plurality of objects O1˜O4 and the user would like to know information about a certain object in the environment. In one embodiment, the user may want to know information about the object O3. The user may point to the object O3 with a hand H of the user and require the information through the AI query AIQ. Further, the AI query AIQ may be performed with the help of the computer vision CV. For example, the computer vision CV may be configured to obtain the hand track TR of the hand H, which may be used to determine an intention of the user by a processor (e.g., an AI).

In one embodiment, the computer vision CV may be implemented as a camera or a sensor. That is, the computer vision CV may be implemented as a complementary metal oxide semiconductor (CMOS) camera, a charge coupled device (CCD) camera, a light detection and ranging (LiDAR) device, a radar, an infrared sensor, an ultrasonic sensor, other similar devices, or a combination of these devices.

However, under some circumstances, the user may have performed a gesture before or after aiming at a region of interest (ROI) (i.e., object O3). That is, a non-ROI object on its way (e.g. the hand track TR) to the ROI or after the ROI may be aimed instead. In other words, the processor may not be able to determine (i.e., select) which object is the correct ROI.

On the other hand, the user may speak a content of the AI query AIQ to require the information of the ROI. However, time points of the gesture and the AI query AIQ may not be consistent. That is, assuming that the processor uses the image at that time to make judgments after understanding the content of the question, the user must deliberately adjust the timing of speech and gestures, such as pointing at the object, in order to obtain an expected result.

In addition, although utilizing video data may be a solution, huge amount of size of the video data may not only cost huge computing power or energy consumption, but also increase a processing time of the object-based operation.

Therefore, it is the pursuit of people skilled in the art to provide an intuitive and convenient way to perform an object-based operation (e.g., query) with the processor.

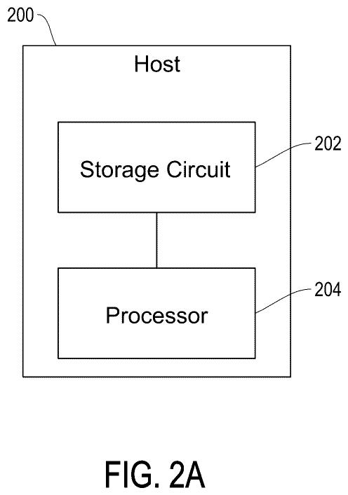

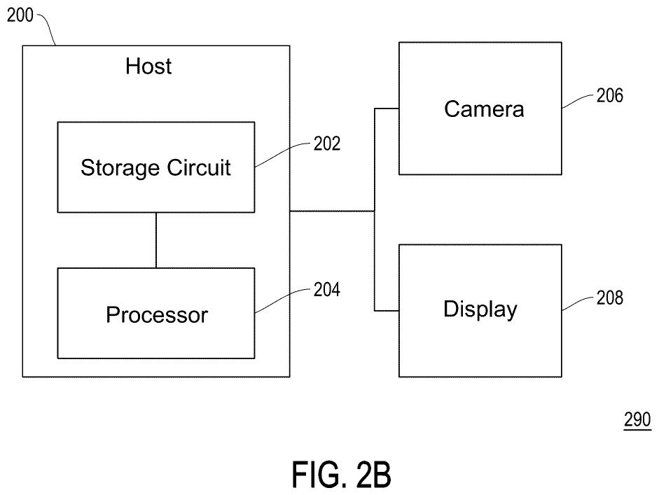

FIG. 2A is a schematic diagram of a host according to an embodiment of the disclosure. In various embodiments, a host 200 may be any smart device and/or computer device. In some embodiments, the host 200 may be any electronic device capable of providing reality services (e.g., AR/VR/MR services, or the like). In some embodiments, the host 200 may be implemented as an XR device, such as a pair of AR/VR glasses and/or a head-mounted device. In some embodiments, the host 200 may be a computer and/or a server, and the host 200 may provide the computed results (e.g., AR/VR/MR contents) to other external display device(s), such that the external display device(s) can show the computed results to the user. However, this disclosure is not limited thereto.

In FIG. 2A, the host 200 includes a storage circuit 202 and a processor 204. The storage circuit 202 is one or a combination of a stationary or mobile random access memory (RAM), read-only memory (ROM), flash memory, hard disk, or any other similar device, and which records a plurality of modules and/or a program code that can be executed by the processor 204.

The processor 204 may be coupled with the storage circuit 202, and the processor 204 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 204 may access the modules and/or the program code stored in the storage circuit 202 to implement an object-based operation method provided in the disclosure, which would be further discussed in the following.

FIG. 2B is a schematic diagram of an object-based operation system according to an embodiment of the disclosure. In FIG. 2B, an object-based operation system 290 may include the host 200, a camera 206, and a display 208. Details of the host 200 may be referred to the description of FIG. 2A, while the details are not redundantly described seriatim herein.

In the embodiments of the disclosure, the camera 206 may be configured to capture an image of the user and the processor 204 may be configured to perform hand tracking of the hand H of the user based on the image. In some embodiments, the camera 206 may be, for example, a complementary metal oxide semiconductor (CMOS) camera, a charge coupled device (CCD) camera, a light detection and ranging (LiDAR) device, a radar, an infrared sensor, an ultrasonic sensor, other similar devices, or a combination of these devices. In some embodiments, the camera 206 may be disposed on a head-mounted device, wearable glasses (e.g., AR/VR goggles), an electronic device, other similar devices, or a combination of these devices. However, this disclosure is not limited thereto.

In the embodiments of the disclosure, the display 208 may be configured to display information to the user, such as information related to the environment. In some embodiments, the display 208 may be, for example, an organic light-emitting diode (OLED) display device, a mini LED display device, a micro LED display device, a quantum dot (QD) LED display device, a liquid-crystal display (LCD) display device, a tiled display device, a foldable display device, an electronic paper display (EPD), other similar devices, or a combination of these devices. In some embodiments, the display 208 may be disposed on a head-mounted device, wearable glasses (e.g., AR/VR goggles), an electronic device, other similar devices, or a combination of these devices. However, this disclosure is not limited thereto.

In some embodiments, the host 200 may further include a communication circuit and the communication circuit may include, for example, a wired network module, a wireless network module, a Bluetooth module, an infrared module, a radio frequency identification (RFID) module, a Zigbee network module, or a near field communication (NFC) network module, but the disclosure is not limited thereto. That is, the host 200 may communicate with external device(s) (such as the camera 206, the display 208 . . . etc.) through either wired communication or wireless communication.

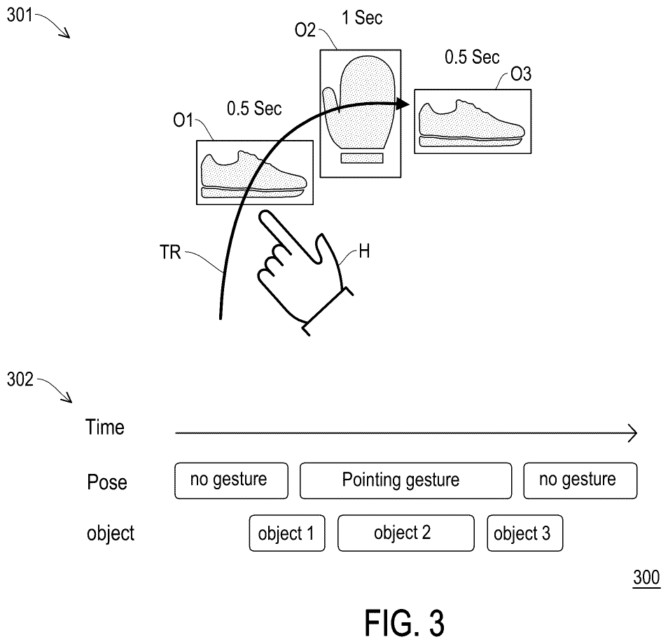

FIG. 3 is a schematic diagram of an object-based operation scenario according to an embodiment of the disclosure. In FIG. 3, an object-based operation scenario 300 includes an operation scenario 301 and a timing sequence 302.

In one embodiment, the operation scenario 301 includes the object O1, the object O2, the object O3, the hand H, and the hand track TR. First of all, an environment image of an environment around a user may be obtained through the camera 206. Further, the processor 204 may be configured to obtain the environment image from the camera 206 and identify one or more objects O1˜O3 in the environment based on the environment image. Furthermore, the processor 204 may be configured to perform a hand tracking to determine the hand track TR of the hand H of the user. Next, the processor 204 may be configured to determine one or more pointing periods of the one or more objects O1˜O3 based on the hand track TR. Moreover, the processor 204 may be configured to determine one of the one or more objects O1˜O3 as the target object based on the one or more pointing periods. In addition, the processor 204 may be configured to perform the object-based operation (e.g., the AI query AIQ) based on the target object. Details will be explained in detail below.

In one embodiment, the timing sequence 302 includes time, pose and object. The pose and the object in the timing sequence 302 respectively represent timing periods of a gesture and an aiming target corresponding to the gesture (e.g., one of the objects O1˜O3).

Reference is made to the operation scenario 301 and the timing sequence 302 together. In one embodiment, the user would like to know information about the object O2. The user may reach out and point to the object O2 with the hand H. For example, the user may move the hand H along the hand track TR for pointing the object O2.

It is noted that, when the user is moving the hand H along the hand track TR, as shown in the timing sequence 302, the hand H may first point to the object O1 (e.g., for 0.5 sec), then point to the object O2 (e.g., for 1 sec), and last point to the object O3 (e.g., for 0.5 sec). Further, when the user moves the hand H along the hand track TR, no special gestures are made by the hand H first until the hand H is moving close to the object O2. Furthermore, when the hand H is moving close to the object O2, the hand H may make a predefined gesture (e.g., pointing gesture). Moreover, after the hand H passes the object O2 and moving away from the object O2, the hand H may make no special gestures again. In addition, the specific gesture (e.g., the pointing gesture) may be configured to trigger the object-based operation (e.g., the AI query AIQ). However, this disclosure is not limited thereto.

It is word mentioned that, when the hand H is in the pointing gesture, the hand H may point to the object O2 for the longest period of time (e.g., a pointing direction of the pointing gesture overlaps the object O2 for the longest period of time). In other words, by comparing a pointing period corresponding to each of the objects O1˜O3, a target object may be determined. A pointing period may be defined as a length of time the pointing gesture is directed at a specific object. For example, when the hand H is moving along the hand track TR, the processor 204 may be configured to determine a start time and an end time of the pointing period corresponding each of the objects O1˜O3. A timing point of a pointing direction of the hand H starting to overlap each of the objects O1˜O3 may be determined as the start time and a timing point of a pointing direction of the hand H stopping to overlap each of the objects O1˜O3 may be determined as the end time. That is to say, the processor 204 may be configured to determine one or more pointing periods of the one or more objects based on the hand track TR. Then, the processor 204 may be configured to determine the target object based on the one or more pointing periods.

In this manner, the object-based operation (e.g., query with AI) may be performed easily and conveniently, thereby improving the user experience.

In embodiment, the pointing periods corresponding to the objects O1˜O3 may be compared with each other to determine whether one of the objects O1˜O3 is the target object or not. That is to say, the processor 204 may be configured to determine a longest pointing period out of the one or more pointing periods. Further, the processor 204 may be configured to determine an object of the one or more objects O1˜O3 corresponding to the longest pointing period as the target object.

In one embodiment, the pointing periods corresponding to the objects O1˜O3 may be compared with a predetermined threshold period to determine whether one of the objects O1˜O3 is the target object or not. That is to say, the processor 204 may be configured to determine that whether a pointing period of the one or more pointing periods is greater than a predetermined threshold period. Further, in response to the pointing period being greater than the predetermined threshold period, the processor 204 may be configured to determine an object of the one or more objects O1˜O3 corresponding to the pointing period as the target object.

In one embodiment, a pointing period corresponding to a second one of the objects O1˜O3 may be compared with a first one and a third one of the objects O1˜O3. That is to say, the one or more objects O1˜O3 may include a first object (e.g., the object O1), a second object (e.g., the object O2), and a third object (e.g., the object O3). Further, the hand H points to the first object, the second object, and the third object in order. Furthermore, in response to a second pointing period corresponding to the second object being greater than a first pointing period corresponding to the first object and a third pointing period corresponding to the third object, the processor 204 may be configured to determine the second object as the target object.

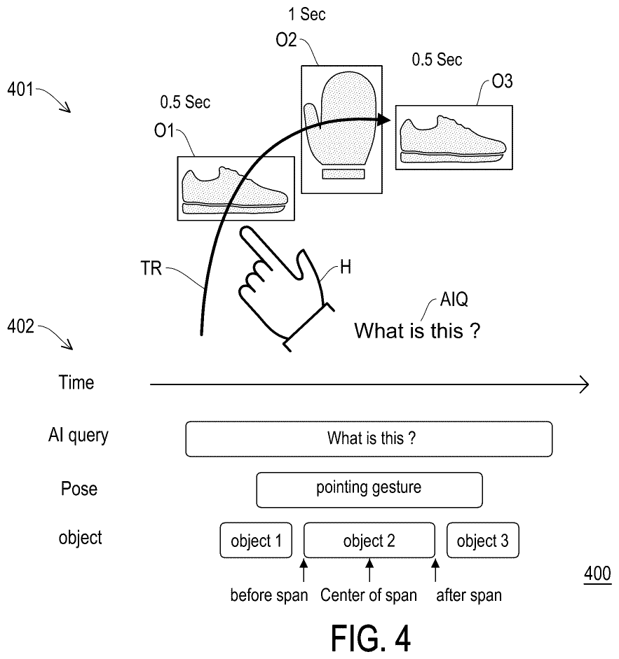

FIG. 4 is a schematic diagram of an object-based operation scenario according to an embodiment of the disclosure. In FIG. 4, an object-based operation scenario 400 includes an operation scenario 401 and a timing sequence 402. Compared with FIG. 3, the difference between FIG. 3 and FIG. 4 is that FIG. 4 further include the AI query AIQ. For the sake of brevity, similar details in FIG. 4 will not be repeated redundantly herein and may be referred to FIG. 3 for further details.

Reference is made to the operation scenario 401 and the timing sequence 402 together. In one embodiment, the user would like to know information about the object O2. The user may reach out and point to the object O2 with the hand H. For example, the user may move the hand H along the hand track TR for pointing the object O2. Further, the user may speak query content of the AI query AIQ out to trigger the AI query AIQ.

It is noted that, as shown in the timing sequence 402, when the user moves the hand H and speak out the query content of the AI query AIQ, the user may speak out the content first, and then point to the target object (e.g., object O2). In other words, for the purpose of saving energy, the camera 206 may be disabled until the user saying the query content out. That is to say, in response to receiving query content of the AI query from the user (e.g., through a microphone, face tracking camera, or a physical/virtual button), the processor 204 may be configured to enable the camera 206. In this manner, the energy consumption may be decrease and the camera 206 will be enabled only on the request of the user to protect the user's privacy, thereby improving the user experience.

It is worth mentioned that, instead of utilizing a whole file of a live video for the object-based operation, utilizing only one single key frame for the object-based operation would be more friendly to the computing power, the energy consumption, and the processing time.

In one embodiment, after the camera 206 is enabled, the camera 206 may be configured to obtain the environment image and the processor 204 may be configured to identify the object O1˜O3 based on the environment image. Then, in order to perform the hand tracking and the object-based operation, the camera 206 may be configured to obtain a live video (which may be also referred to as a hand tracking video). It is noted that, the live video may be also used to identify the objects O1˜O3. However, this disclosure is not limited thereto.

It is worth mentioned that, the key frame for the object-based operation may be determined based on the pointing period. For example, the pointing period corresponding to the target object (e.g., object O2) may use one “span” in time. An image of a frame in the span or close to the span may be used to perform the object-based operation. In one embodiment, a frame in the center of the span may be used to perform the object-based operation. In another embodiment, a frame right before the span (e.g., right before a point direction of the hand H starts to overlap target object) may be used to perform the object-based operation. In yet another embodiment, a frame right after the span (e.g., right after a point direction of the hand H stops to overlap target object) may be used to perform the object-based operation. However, this disclosure is not limited thereto.

That is, the processor 204 may be configured to obtain a hand tracking video of the hand tracking. Further, the processor 204 may be configured to obtain a target frame of the hand tracking video as a target image based on the pointing period. For example, depending on system setting or user setting, the target frame may be any one specified frame in, before, or after the pointing period corresponding to the target object. Furthermore, the processor 204 may be configured to perform the object-based operation (e.g. AI query AIQ) based on the target image. In this manner, only the target frame is utilized for the AI query AIQ, thereby becoming more friendly to the computing power, the energy consumption, and the processing time.

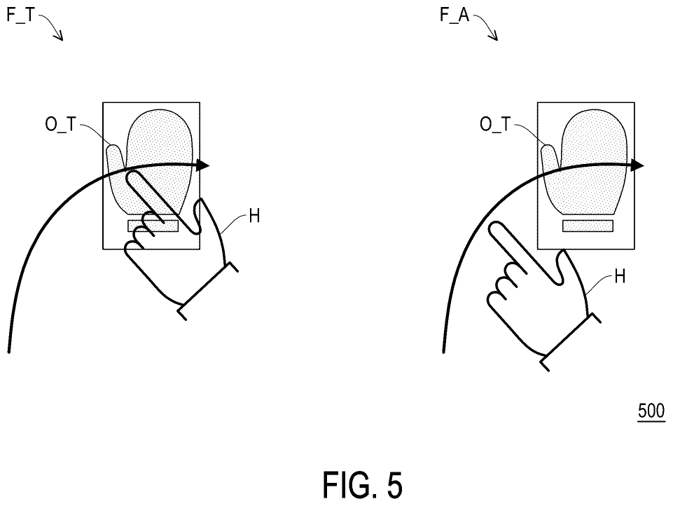

FIG. 5 is a schematic diagram of an object-based operation scenario according to an embodiment of the disclosure. In FIG. 5, an object-based operation scenario 500 includes a target frame F_T and an alternative frame F_A. Reference is made to FIG. 4 and FIG. 5 together. In one embodiment, the target frame F_T may be a frame in the center of the span and the alternative frame F_A may be a frame before the span. However, this disclosure is not limited thereto.

In one embodiment, after the target object O_T is determined, a frame including the target object O_T may be selected from frames of the hand tracking video. For example, a frame that the hand H is right pointing to the target object O_T may be select as a target frame F_T. However, in some embodiment, when the hand H is too closed to the target object O_T or due to a position of the user, part of the target object O_T may be blocked by the hand H in the target frame F_T. For example, as shown in the target frame F_T, lower part of the target object O_T is blocked by the hand H.

In order to obtain full information of the target object O_T, the alternative frame F_A may be selected alternatively. That is, the processor 204 may be configured to determine a frame in the middle of the pointing period corresponding to the target object O_T as the target frame F_T. Further, the processor 204 may be configured to determine that whether the target object O_T is at least partly blocked by the hand H in the target frame F_T. Furthermore, in response to the target object O_T being at least partly blocked by the hand H, the processor 204 may be configured to determine a frame right before or after the pointing period corresponding to the target object O_T (e.g., alternative frame F_A) as the target frame F_T. In this manner, an optimal image may be utilized for the object-based operation, thereby improving the user experience.

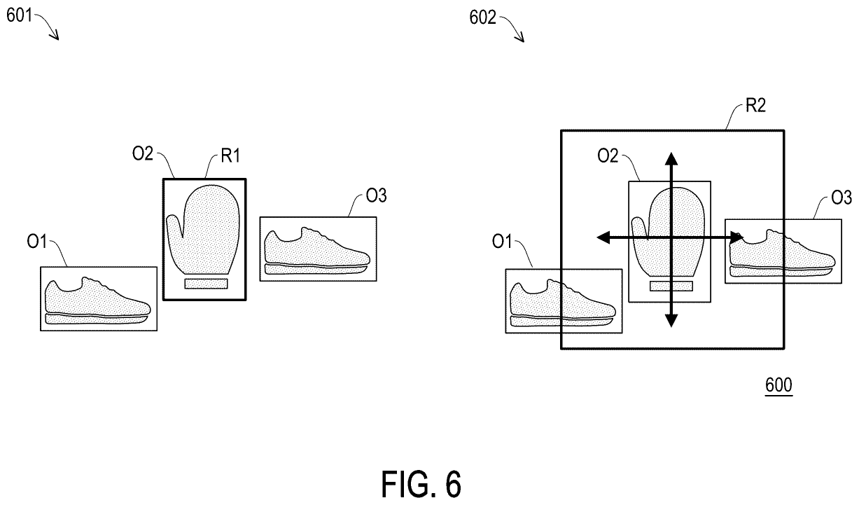

FIG. 6 is a schematic diagram of an object-based operation scenario according to an embodiment of the disclosure. In FIG. 6, an object-based operation scenario 600 includes a cropping scenario 601 and a cropping scenario 602. The cropping scenario 601 and the cropping scenario 602 both include the object O1, the object O2, and the object O3. In one embodiment, the object O2 may be the target object O_T. Further, the cropping scenario 601 includes a ROI R1 and the cropping scenario 602 include a ROI R2.

Reference is first made to the cropping scenario 601. After the target object O_T is determined, the target image of the target frame may be selected from the frames of the hand tracking video and utilized as the ROI for the object-based operation. It is noted that, in order to further save the computing power, decease the energy consumption, and/or deceasing the processing time, instead of utilizing the whole image of the target image as the ROI, part of the target image may be utilized as the ROI.

In one embodiment, as shown in the cropping scenario 601, only the target object O_T (e.g., object O2) may be cropped as the ROI (e.g. the ROI R1). That is, the processor 204 may be configured to crop the target object O_T of the target image as the ROI. Further, the processor 204 may be configured to perform the object-based operation based on the ROI.

In another embodiment, as shown in the cropping scenario 602, not only the target object O_T but also an area near the target object O_T may be cropped together as the ROI. That is, the processor 204 may be configured to cropping a target area extending a specific distance from the target object O_T of the query image as the ROI. The specific distance may be predetermined according to design needs or user's preference. Further, the processor 204 may be configured to perform the object-based operation based on the ROI. In this manner, more computing power, energy, and/or processing time may be saved, thereby improving the user experience.

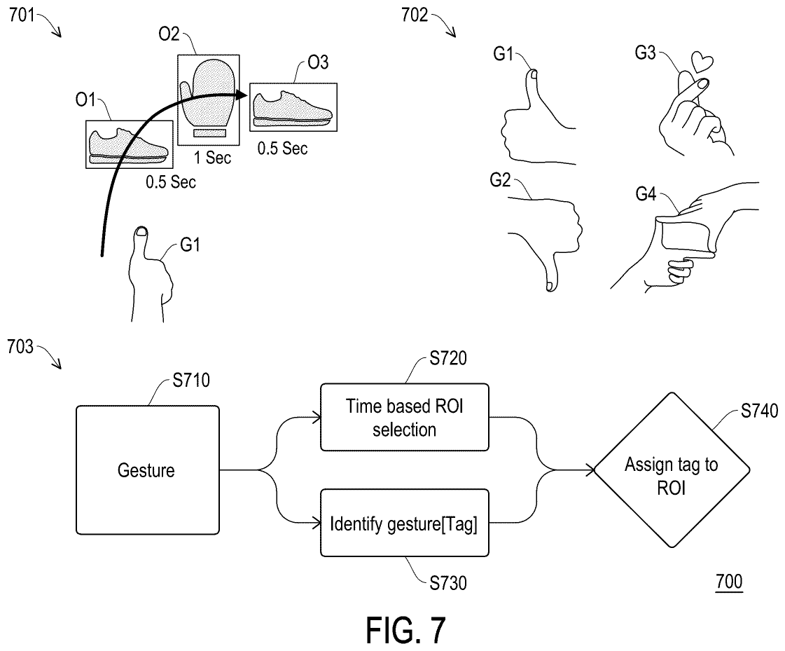

FIG. 7 is a schematic diagram of an object-based operation scenario according to an embodiment of the disclosure. In FIG. 7, an object-based operation scenario 700 includes a tagging scenario 701, a gesture database 702, and a tagging method 703. That is, in one embodiment, the object-based operation may be tagging an object. However, this disclosure is not limited thereto.

Reference is first made to the tagging scenario 701. The environment may include the object O1, the object O2, and the object O3. In one embodiment, the user would like to assign a tag to the object O2. For example, the user may perform a tagging gesture G1 and the tagging gesture G1 points to the object O2. By comparing the pointing periods corresponding to the objects O1˜O3, the object O2 may be determined as the target object O_T and the object O2 may be assigned with the tag. That is, the processor 204 may be configured to determine that whether the hand H is in a tagging gesture G1 or not based on the hand tracking. Further, in response to the hand H being in the tagging gesture, the processor 204 may be configured to assign a tag to the target object based on the tagging gesture G1. In this manner, the user may be able to assign a tag to an object, for example, the object-based operation may further include a save operation to store the target object O_T (e.g., the ROI R1) along with the tag(s) (e.g., the tagging gesture G1) in a database or album in the storage circuit 202, or to send to another device for further processing.

Reference is then made to the gesture database 702. The gesture database 702 may include a plurality of tagging gestures G1˜G4. That is, by performing different tagging gestures G1˜G4, the user may assign different tags to a same object or different objects, thereby improving the user experience.

Reference is now made to the tagging method 703. The tagging method 703 includes steps S710˜S740. In the step S710, the processor 204 may be configured to determine that whether the user is performing a gesture or not. In the step S720, the processor 204 may be configured to determine the ROI based on the pointing periods corresponding to the objects O1˜O3. In the step S730, the processor 204 may be configured to identify that whether the gesture is one of the tagging gestures G1˜G4. In the step S740, the processor 204 may be configured to assign the tag to the ROI (e.g., the target object O_T).

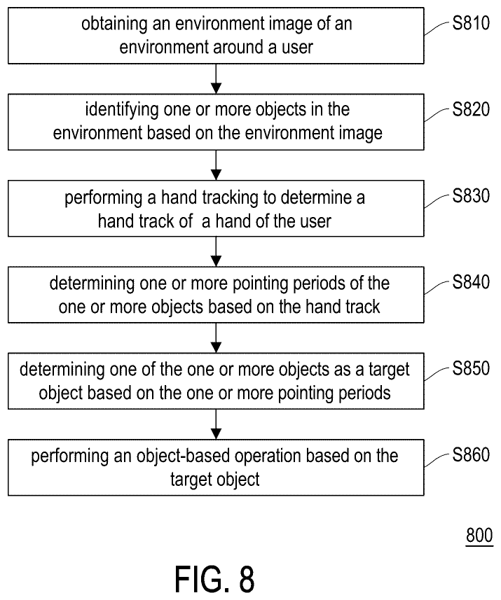

FIG. 8 is a schematic flowchart of an object-based operation method according to an embodiment of the disclosure. In FIG. 8, an object-based operation method 800 includes steps S810˜S860.

In the step S810, the processor 204 may be configured to obtain an environment image of an environment around a user. In the step S820, the processor 204 may be configured to identifying one or more objects O1˜O3 in the environment based on the environment image. In the step S830, the processor 204 may be configured to perform a hand tracking to determine the hand track TR of the hand H of the user. In the step S840, the processor 204 may be configured to determine one or more pointing periods of the one or more objects O1˜O3 based on the hand track TR. In the step S850, the processor 204 may be configured to determine one of the one or more objects O1˜O3 as the target object O_T based on the one or more pointing periods. In the step S860, the processor 204 may be configured to perform the object-based operation based on the target object O_T. In this manner, the object-based operation may be performed easily and conveniently.

In addition, the implementation details of the object-based operation method 800 may be referred to the descriptions of FIG. 1 to FIG. 7 to obtain sufficient teachings, suggestions, and implementation embodiments, while the details are not redundantly described seriatim herein.

In summary, according to the host 200, the object-based operation system 290, and the object-based operation method 800, the target object O_T may be determined based on the hand track TR. Therefore, the target object O_T may be determined accurately and easily, thereby improving the user experience.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A host, comprising:
a storage circuit, configured to store a program code; and
a processor, coupled to the storage circuit and configured to access the program code to execute:
obtaining an environment image of an environment around a user;
identifying one or more objects in the environment based on the environment image;
performing a hand tracking to determine a hand track of a hand of the user;
determining one or more pointing periods of the one or more objects based on the hand track;
determining one of the one or more objects as a target object based on the one or more pointing periods; and
performing an object-based operation based on the target object.

2. The host according to claim 1, wherein the processor is further configured to access the program code to execute:
determining a longest pointing period out of the one or more pointing periods;
determining an object of the one or more objects corresponding to the longest pointing period as the target object.

3. The host according to claim 1, the processor is further configured to access the program code to execute:
determining that whether a pointing period of the one or more pointing periods is greater than a predetermined threshold period; and
in response to the pointing period being greater than the predetermined threshold period, determining an object of the one or more objects corresponding to the pointing period as the target object.

4. The host according to claim 1, wherein
the one or more objects comprises a first object, a second object, and a third object,
the hand points to the first object, the second object, and the third object in order, and
the processor is further configured to access the program code to execute:
in response to a second pointing period corresponding to the second object being greater than a first pointing period corresponding to the first object and a third pointing period corresponding to the third object, determining the second object as the target object.

5. The host according to claim 1, wherein the object-based operation is an artificial intelligence query.

6. The host according to claim 5, wherein the processor is further configured to access the program code to execute:
in response to receiving query content of the artificial intelligence query from the user, enabling the camera.

7. The host according to claim 1, wherein the processor is further configured to access the program code to execute:
obtaining a hand tracking video of the hand tracking;
obtaining a target frame of the hand tracking video as a target image based on the pointing period; and
performing the object-based operation based on the target image.

8. The host according to claim 7, wherein the processor is further configured to access the program code to execute:
determining a frame in the middle of the pointing period corresponding to the target object as the target frame;
determining that whether the target object is at least partly blocked by the hand in the target frame; and
in response to the target object being at least partly blocked by the hand, determining a frame right before or after the pointing period corresponding to the target object as the target frame.

9. The host according to claim 7, wherein the processor is further configured to access the program code to execute:
cropping the target object of the target image as a region of interest; and
performing the object-based operation based on the region of interest.

10. The host according to claim 7, wherein the processor is further configured to access the program code to execute:
cropping a target area extending a specific distance from the target object of the target image as a region of interest; and
performing the object-based operation based on the region of interest.

11. The host according to claim 1, wherein the processor is further configured to access the program code to execute:
determining that whether the hand is in a tagging gesture or not based on the hand tracking; and
in response to the hand being in the tagging gesture, assigning a tag to the target object based on the tagging gesture.

12. An object-based operation system, comprising:
a camera, configured to obtain an environment image of an environment around a user;
a display configured to display information about the environment to the user;
a storage circuit, configured to store a program code; and
a processor, coupled to the storage circuit and configured to access the program code to execute:
obtaining the environment image from the camera;
identifying one or more objects in the environment based on the environment image;
performing a hand tracking to determine a hand track of a hand of the user;
determining one or more pointing periods of the one or more objects based on the hand track;
determining one of the one or more objects as a target object based on the one or more pointing periods; and
performing an object-based operation based on the target object.

13. The object-based operation system according to claim 12, wherein the processor is further configured to access the program code to execute:
determining a longest pointing period out of the one or more pointing periods;
determining an object of the one or more objects corresponding to the longest pointing period as the target object.

14. The object-based operation system according to claim 12, the processor is further configured to access the program code to execute:
determining that whether a pointing period of the one or more pointing periods is greater than a predetermined threshold period; and
in response to the pointing period being greater than the predetermined threshold period, determining an object of the one or more objects corresponding to the pointing period as the target object.

15. The object-based operation system according to claim 12, wherein
the one or more objects comprises a first object, a second object, and a third object,
the hand points to the first object, the second object, and the third object in order, and
the processor is further configured to access the program code to execute:
in response to a second pointing period corresponding to the second object being greater than a first pointing period corresponding to the first object and a third pointing period corresponding to the third object, determining the second object as the target object.

16. The object-based operation system according to claim 12, wherein the object-based operation is an artificial intelligence query.

17. The object-based operation system according to claim 16, wherein the processor is further configured to access the program code to execute:
in response to receiving query content of the artificial intelligence query from the user, enabling the camera.

18. The object-based operation system according to claim 12, wherein the processor is further configured to access the program code to execute:
obtaining a hand tracking video of the hand tracking;
obtaining a target frame of the hand tracking video as a target image based on the pointing period; and
performing the object-based operation based on the target image.

19. The object-based operation system according to claim 12, wherein the processor is further configured to access the program code to execute:
determining that whether the hand is in a tagging gesture or not based on the hand tracking; and
in response to the hand being in the tagging gesture, assigning a tag to the target object based on the tagging gesture.

20. An object-based operation method, comprising:
obtaining, through a camera, an environment image of an environment around a user;
identifying, through a processor, one or more objects in the environment based on the environment image;
performing, through the processor, a hand tracking to determine a hand track of a hand of the user;
determining, through the processor, one or more pointing periods of the one or more objects based on the hand track;
determining, through the processor, one of the one or more objects as a target object based on the one or more pointing periods; and
performing, through the processor, an object-based operation based on the target object.
